(19) United States
(12) Patent Application Publication
(10) Pub. No.: US 2016/0240110 A1
(43) Pub. Date: Aug. 18, 2016

(54) Sheets Labels

(71) Applicant: SANFORD, L.P., Downers Grove, IL (US)

(72) Inventors: Stefaan Van Den Broecke, Kalamazoo, MI (US); Bram Boot, Antwerpen (BE); Jasper Blockx, Mechelen (BE); Ron Jacobs, Acworth, GA (US); Stephen Spencer, Atlanta, GA (US)

(21) Appl. No.: 15/040,745

(22) Filed: Feb. 10, 2016

Related U.S. Application Data
(60) Provisional application No. 62/115,235, filed on Feb. 12, 2015.

(51) Int. Cl. G09F 3/02; G09F 3/10

(52) U.S. Cl. CPC G09F 3/02; G09F 3/10

(57) ABSTRACT

A sheet of labels comprising: a backing layer forming a reverse side of the sheet of labels; and an image receiving layer attached to the backing layer, the image receiving layer comprising a plurality of removable labels and forming a front side of the sheet of labels; the backing layer comprising at least one identifier associated with each of the plurality of labels, one or more of the at least one identifier being at least partially visible from the front side of the sheet of labels.

### CROSS-REFERENCE TO RELATED APPLICATION

This application claims the benefit of the filing date of U.S. Provisional Application No. 62/115,235, filed Feb. 12, 2015. U.S. Provisional Application No. 62/115, 235, is hereby incorporated by reference.

### BACKGROUND

The present application relates to a supply of labels for printing, and methods and apparatus for the preparation of labels to be printed. More particularly the application relates to a sheet of labels and methods and apparatus for printing on the sheet of labels.

Known label printing apparatuses are disclosed in EP-A-322918 and EP-A-322919 (Brother Kogyo Kabushiki Kaisha) and EP-A-267890 (Varitronic). In other known tape printing apparatuses, so-called direct thermal tapes are used, in which an image is created directly onto the direct thermal tape without the interposition of an ink ribbon cassette. Elements of a print head are heated, and the heat causes chemicals within the direct thermal tape to react and produce an image in or on the tape. Other known printing apparatuses include ink-jet printers and laser printers. In ink-jet printers droplets of ink are ejected from an ink-cartridge on to a printing substrate (e.g. paper). In laser printing electrically charged, powdered ink (toner) is collected on an electron-charged, cylindrical drum which is then transferred to a printing substrate (e.g. paper). The substrate may then be heated in order to permanently fuse the printed image to the substrate. Office printers are typically of the ink-jet or laser variety. The image receiving medium in office printers is typically in a sheet format.

The apparatuses of the type described above are provided with or are in communication with a device or system comprising an input means, such as a keyboard (which may be a hardware keyboard or a touchscreen), which enables a user to enter characters, symbols and the like to form an image to be printed by the printer. The keyboard usually has text character keys and number keys for entering letters and numbers respectively, plus some function keys which, among other things, operate menus and allow printing attributes to be set.

In some label printer systems, a user creates or edits a label for printing using a PC, and then sends print data to a printer to cause the printer to print the print data onto a label medium. In such label printer systems, the user will view a display of the PC to create a label, rather than a display of the printer. Also, the label-editing software used for creating the label will be stored and run on the PC, rather than the printer.

In contrast, other label printer systems are operable independently of a PC or other computer to create and print a label. Although some of these stand-alone printer systems are connectable to a PC or other computer to receive some data, some may nevertheless be operable independently of the PC or other computer to create a label for printing, since label-editing software used for creating the label is stored and run on the label printer itself. A stand-alone label printer system may usually include an integral display via which the user can view an interface of the label-editing software.

The label supply can be provided in a number of ways. The label supply can be a continuous supply of tape, or a supply of die-cut labels peelable from a backing layer. In some embodiments multiple labels can be arranged in a grid fashion on a sheet (such as an A4 sized sheet), and printed on an appropriate printer.

### SUMMARY

In a first aspect there is provided a sheet of labels comprising: a backing layer forming a reverse side of the sheet of labels; and an image receiving layer attached to the backing layer, the image receiving layer comprising a plurality of removable labels and forming a front side of the sheet of labels; the backing layer comprising at least one identifier associated with each of the plurality of labels, one or more of the at least one identifier being at least partially visible from the front side of the sheet of labels.

According to some embodiments, one or more of the at least one identifier is at least partially visible from the front side of the sheet of labels through at least the backing layer.

According to some embodiments, one or more of the at least one identifier is at least partially visible from the front side of the sheet of labels through at least the backing layer at a location associated with a removed label from the plurality of labels.

According to some embodiments, the location is directly underneath the removed label.

According to some embodiments, one or more of the at least one identifier is at least partially visible from the front side of the sheet of labels through the image receiving layer at a location associated with a label that has not been removed from the plurality of labels.

According to some embodiments, the backing layer comprises a first side and a second side, an adhesive layer attached to the first side, and the second side comprising the reverse side of the sheet of labels.

According to some embodiments, the at least one identifier comprises a marking printed on the first side of the backing layer.

According to some embodiments, the at least one identifier comprises a marking printed on the second side of the backing layer.

According to some embodiments, the at least one identifier is printed on the second side in a reverse manner, so that the at least one identifier is visible in a forward manner from the front side.

According to some embodiments, the sheet of labels comprises a plurality of identifiers, each identifier associated with a respective one of said plurality of labels.

According to some embodiments, the plurality of identifiers are arranged in a grid.

According to some embodiments, the plurality of identifiers comprise a plurality of different characters or character strings, each character or character string representing a respective one of said plurality of labels.

According to some embodiments, each character or character string comprise one or more numbers and/or letters.

In a second aspect there is provided a method of manufacturing a sheet of labels comprising: providing a backing layer forming a reverse side of the sheet of labels;

providing at least one identifier on the backing layer; providing an image receiving layer, the image receiving layer comprising a plurality of removable labels and configured to form a front side of the sheet of labels; and attaching the backing layer to the image receiving layer, the at least one identifier being associated with the plurality of labels and the at least one identifier being visible from the front side of the plurality of labels through the image receiving layer.

According to some embodiments, the method comprises locating the at least one identifier directly underneath the plurality of removable labels.

According to some embodiments, the backing layer comprises a first side and a second side, the method comprising applying an adhesive layer to the first side, the second side comprising the reverse side of the sheet of labels.

According to some embodiments, the method comprises printing the at least one identifier on the first side of the backing layer.

According to some embodiments, the method comprises printing the identifier on the second side of the backing layer.

According to some embodiments, the method comprises printing the identifier on the second side in a reverse manner, so that the at least one identifier is visible in a forward manner from the front side.

According to some embodiments, the method comprises providing a plurality of identifiers, each identifier associated with a respective one of said plurality of labels.

According to some embodiments, the method comprises arranging the plurality of identifiers in a grid.

According to some embodiments, the method comprises providing the plurality of identifiers as a plurality of different characters or character strings, each character or character string representing a respective one of said plurality of labels.

According to some embodiments, the method comprises providing each character or character string as one or more numbers and/or letters.

According to a third aspect there is provided a method of controlling a display comprising: displaying on a user interface for controlling a printer an image representative of a sheet comprising a plurality of labels; displaying on the image representative of a sheet of labels at least one identifier, the identifier associated with at least one of said labels in the image; the identifier indicative of an association between the labels displayed in the image and one or more labels on a sheet of labels capable for printing in a printer.

According to some embodiments, a content of the at least one identifier in the image is the same as a content of a corresponding identifier on a sheet of labels to be printed in a printer.

According to some embodiments, the method comprises providing in the image representative of a sheet of labels an identifier associated with each label.

According to some embodiments, each identifier comprises a character or a character string.

According to some embodiments, each character or character string comprises one or more numbers and/or letters.

According to some embodiments, the method comprises enabling a user to enter data to be printed in to the image representative of a sheet of labels.

According to some embodiments, the method comprises enabling a user to select a start point for the data to be printed, the start point comprising a label in the plurality of labels upon which the data will be first printed.

According to some embodiments, the method comprises enabling a user to change the start point for the data to be printed.

According to some embodiments, the method comprises enabling a user to select one or more subsequent label representations to serve as subsequent label locations for data to be printed.

According to some embodiments, one or more of the one or more subsequent label representations selected are not adjacent or sequential in orientation.

According to some embodiments, the method comprises updating the image representative of a sheet of labels in response to a change of start point.

According to some embodiments, updating the image comprises one or more of: causing label data to move to a next or previous row of labels on the label sheet; causing label data to move to a next or previous sheet.

According to a fourth aspect there is provided a computer program comprising computer executable instructions which when run on one or more processors perform the method of the third aspect.

According to a fifth aspect there is provided an apparatus comprising: a display; a controller configured to control the display to display on a user interface for controlling a printer an image representative of a sheet comprising a plurality of labels; and display on the image representative of a sheet of labels at least one identifier, the identifier associated with at least one of said labels in the image; the identifier indicative of an association between the labels displayed in the image and one or more labels on a sheet of labels capable for printing in a printer.

According to some embodiments, a content of the at least one identifier in the image is the same as a content of a corresponding identifier on the sheet of labels to be printed in a printer.

According to some embodiments, the controller is configured to provide in the image representative of a sheet of labels an identifier associated with each label.

According to some embodiments, each identifier comprises a character or a character string.

According to some embodiments, each character or character string comprises one or more numbers and/or letters.

According to some embodiments, the apparatus is configured to enable a user to enter data to be printed in to the image representative of a sheet comprising a plurality of labels.

According to some embodiments, the apparatus is configured to enable a user to select a start point for the data to be printed in the image representative of a sheet comprising a plurality of labels.

According to some embodiments, the apparatus is configured to enable a user to select one or more subsequent label representations to serve as subsequent label locations for data to be printed.

According to some embodiments, one or more of the one or more subsequent label representations selected are not adjacent or sequential in orientation

According to some embodiments, the apparatus is configured to enable a user to change the start point for the data to be printed.

According to some embodiments, the controller is configured to update the image representative of a sheet of labels in response to a change of start point.

According to some embodiments, the updating the image comprises one or more of: causing label data to move to a next or previous row of labels on the label sheet; causing label data to move to a next or previous sheet.

### BRIEF DESCRIPTION OF FIGURES

FIG. 1 is a simplified diagram of a printing system;

FIG. 2 shows a sheet of labels;

FIG. 3 is a sectional diagram through a sheet of labels (not to scale);

FIG. 4 is a schematic diagram showing some aspects of a printer system;

FIG. 5 shows a reverse side of a sheet of labels, according to an embodiment;

FIG. 6 shows a front side of the sheet of labels of FIG. 5;

FIGS. 7A and 7B are front and reverse sides respectively of a sheet of labels, according to an embodiment;

FIG. 8 shows a home screen of a user interface, according to an embodiment;

FIG. 9 shows a pop-up screen according to an embodiment;

FIG. 10 shows a user interface screen for preparing a label, according to an embodiment;

FIG. 11 is a continuation of the user interface screen of FIG. 10;

FIGS. 12A and 12B show an icon of a user interface, according to an embodiment;

FIG. 13 shows a further pop-up screen, according to an embodiment;

FIG. 14 shows an icon of a user interface, according to an embodiment;

FIG. 15 shows a portion of a user interface during a label creation process, according to an embodiment;

FIG. 16 is a continuation of the user interface of FIG. 15;

FIG. 17 is a continuation of the user interfaces of FIGS. 15 and 16;

FIGS. 18A to 18C show user interface screens according to an embodiment.

### DETAILED DESCRIPTION

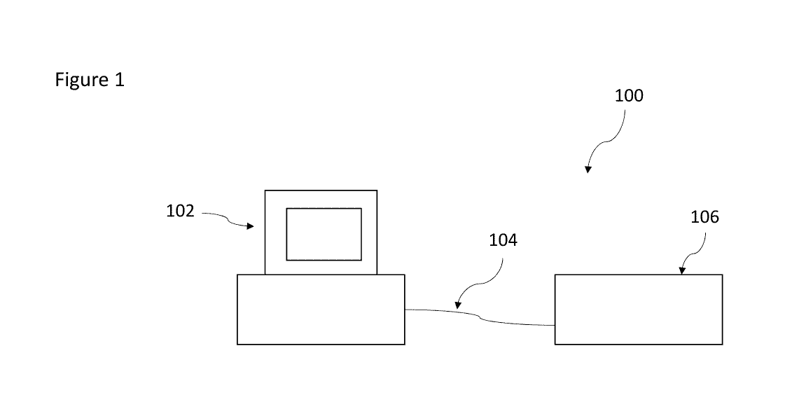

A printing system 100 is generally shown in FIG. 1. The printing system 100 comprises a computer apparatus 102 operatively connected to a printer 106, via a connection 104. The connection 104 may be wired or wireless. The printer 106 may be of any of the types described above e.g. a thermal printer, ink-jet printer, laser printer etc. The computer apparatus 102 and printer 106 may be integrated in a stand-alone printing apparatus. As will be explained in more detail below, in embodiments a user can control the computer apparatus 102 to prepare one or more labels to be printed on the printer 106.

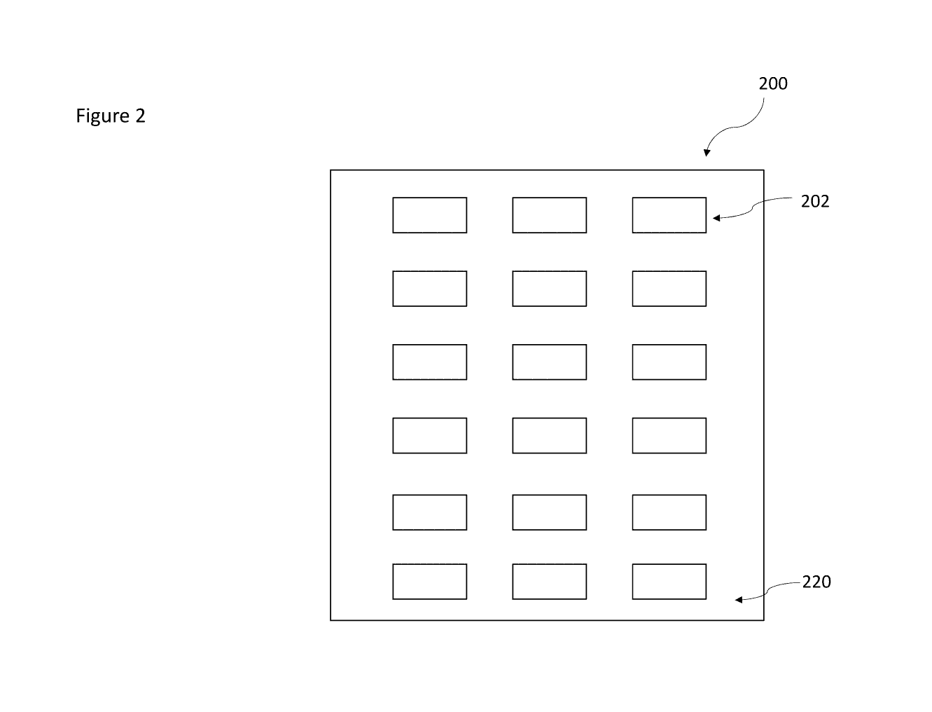

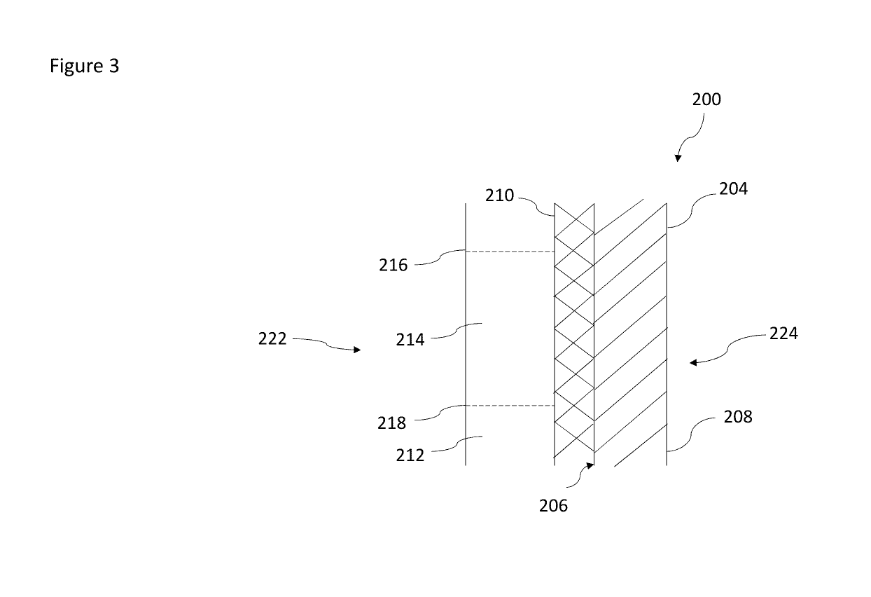

An example of a sheet of labels 200 is described with respect to FIGS. 2 and 3. The sheet of labels 200 comprises a plurality of labels 202 adhered to a backing layer by an adhesive. This is shown in more detail in FIG. 3, which is a sectional view through the sheet of labels 200 (FIG. 3 is not drawn to scale). The sheet of labels 200 comprises a backing layer 204. The backing layer 204 comprises a first side 206 and a second side 208. The second side 208 forms a reverse side of the sheet of labels 200. An adhesive layer 210 is applied to the first side 206 of the backing layer 204. An image receiving layer 212 is attached to the backing layer 204 by the adhesive layer 210. A label of the plurality of labels 202 is shown at 214. The label 214 is die-cut in the image receiving layer 212, as shown by perforations 216 and 218. Therefore the label 214 can be peeled away from the backing layer 204. The image receiving layer 212 may be considered to form a front side 222 of the sheet 200, and the backing layer 204 may be considered to form a reverse side 224 of the sheet 200. It is possible in some embodiments one or more additional layers may be included, such as protective coatings, laminated layers, or any other layer or layers as are known in the art. It is also possible that in other embodiments the adhesive layer may be omitted. In such a case the backing layer may be directly attached to the image receiving layer. In such an embodiment a backing layer and an image receiving layer which are attracted to each other may be used, which attraction may be caused for example by use of different materials for the two layers. In further embodiments an adhesive may be used but only at select locations (for example only where labels will be located), rather than as a layer across the entire sheet.

The sheet of labels 200 may be loaded in to an appropriate printer, and printed on in any suitable way (e.g. thermal printing, laser printing, ink-jet printing etc.). A print program comprising a suitable user interface may be loaded on computer apparatus 102 to enable a user to design one or more labels to be printed on label sheet 200. After printing, a user can peel off the printed labels and affix them to any object as needed e.g. electrical wires or cables, office stationery etc. Once the labels are peeled off, a web of material 220 between the labels 202 may remain attached to the backing layer 204.

If a user prints on fewer than all of the labels 202 on the sheet, then there is a problem that the user cannot re-use that sheet for printing on any of the remaining labels. The remaining labels will then be wasted, which is frustrating for the user as well as a waste of material. Part of the problem is that when printing on to label sheets the computer apparatus 102 and/or printer 106 are configured to start printing from the first label on the sheet, which is usually the top left label. If this first label has already been printed on and/or been removed from the label sheet, then the user cannot easily begin printing from any of the other remaining labels on the sheet.

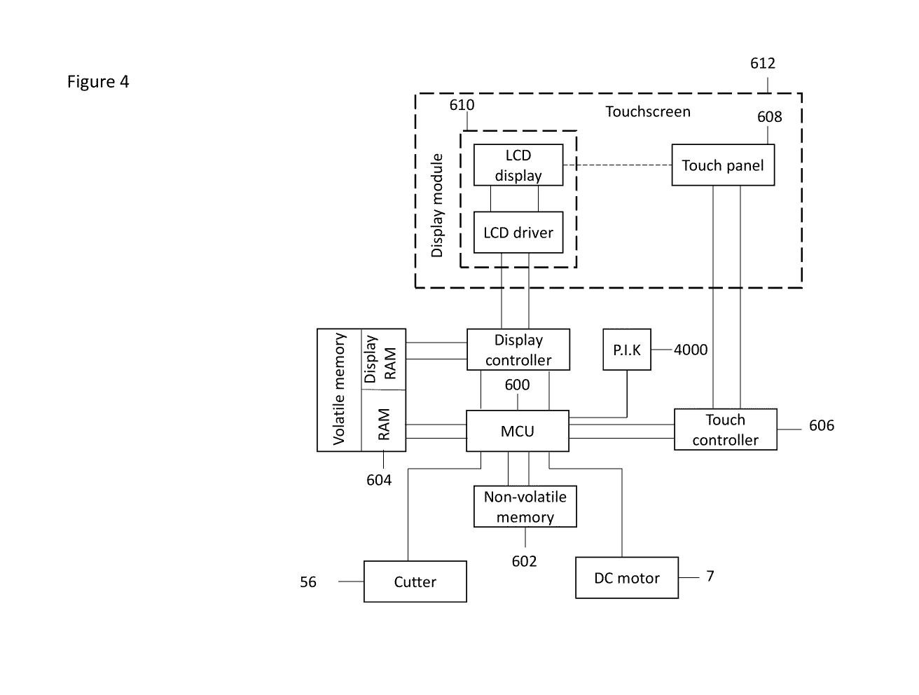

Basic circuitry for controlling the printer 106 of FIG. 1 is shown in FIG. 4. There is a controller or “control means” (such as a micro controller unit (MCU) or processor) 600, a non-volatile memory 602 which is for example a read only memory (ROM) or a flash type of memory. The flash type of memory may be used in place of, or in addition to the read only memory. A volatile memory comprising a random access memory RAM 604 and/or display RAM is also provided. The MCU 600 is connected to receive label data input to it from a data input device such as a touch panel 608 of a touchscreen 612 via a touch panel controller 606. In alternative embodiments, the data input device may comprise one or more of a hardware keyboard including plural keys, a mouse, a digital pen or tracker ball, or any other means for enabling a user to send commands to the controller 600. In some embodiments, the touchscreen 612 is omitted. The MCU 600 outputs data to drive the display 610 (which together with the touch panel 608 form the touchscreen 612) to display a label to be printed (or a part thereof) and/or a message for the user. Additionally, the MCU 600 also outputs data to drive the print head 18 so that the label data is printed onto the image receiving tape to form a label. The MCU 600 also controls the motor 7 for driving, for example, a platen or medium transporting mechanism of the label printing apparatus. The MCU 600 may also control a cutting mechanism of the device shown in FIG. 1 to allow a length of tape or other image receiving medium to be cut off. In alternative embodiments at least part of the cutting mechanism may be manually operated.

It should also be understood that where the printer 106 is connected to an external apparatus such as a PC 102, then the PC also contains similar components such as at least one memory and at least one processor to enable the PC to carry out the operations of creating a label to be printed. Such a PC will also be connected to a display means such as a monitor. It should be appreciated that the label printer may be connected to any other suitable device such as a tablet, or mobile phone.

Hereafter it should be understood that labels may be created on either or both of the printing apparatus itself or on an external apparatus such as a PC connected to the label printer. Accordingly, it shall be understood that hereafter terms such as “memory”, “processor” and “display” may refer to these components on either or both of a label printing apparatus and a PC.

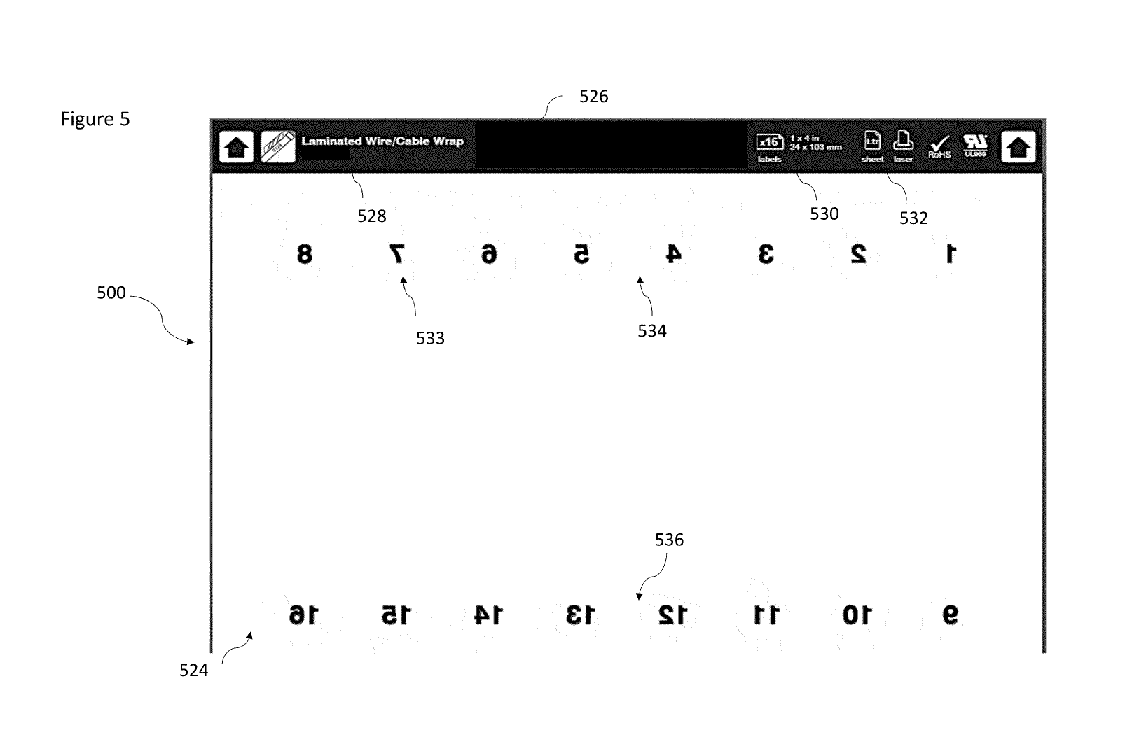

FIG. 5 shows a label sheet according to an embodiment. More particularly FIG. 5 shows a reverse side 524 of a sheet of labels 500. The sheet of labels 500 may comprise a header region 526 which is pre-printed on to the reverse side 524 of the label sheet. An identical or similar header may also or alternatively be provided on the front side of the label sheet 500. The header region provides information to a user. For example region 528 tells a user that the sheet comprises labels suitable for attachment to a laminated wire/cable. Region 530 gives information on the number of labels on the sheet and the size of the labels. In this example there are 16 labels on the sheet and the size of each label is 1×4 in/24×103 mm. Region 532 informs the user that the labels are in sheet form and are suitable for printing on a laser printer.

Within the borders of the reverse side 524 of the label sheet a number of identifiers or markings 533 are shown. In this example the identifiers comprise numbers 1 to 16. The numbers 1 to 8 are comprised in a first row of identifiers 534, and the numbers 9 to 16 are comprised in a second row 536. The numbers are positioned on the reverse side 524 so as to align with corresponding labels on the front side of the label sheet 500. For example, in this embodiment, the number “1” is aligned with a top left label of the label sheet when viewed from the front side, and the number “16” is aligned with a bottom right label of the label sheet when viewed from the front side. By “aligned” is meant that a user is able to associate an identifier with a particular label. The identifier could be located within the bounds of a label, or to the side or top or bottom of a given label. Where the identifier is comprised within the bounds of a label (when viewed from the front side) the identifier may be positioned anywhere within the label e.g. centre aligned, left aligned, right aligned, or any position therebetween. The identifiers 533 (in this case numbers 1 to 16), can be printed on either side of the backing layer 524. For example with respect to FIG. 3, the numbers may be printed on either the first side 206 or the second side 208 of the backing layer 204.

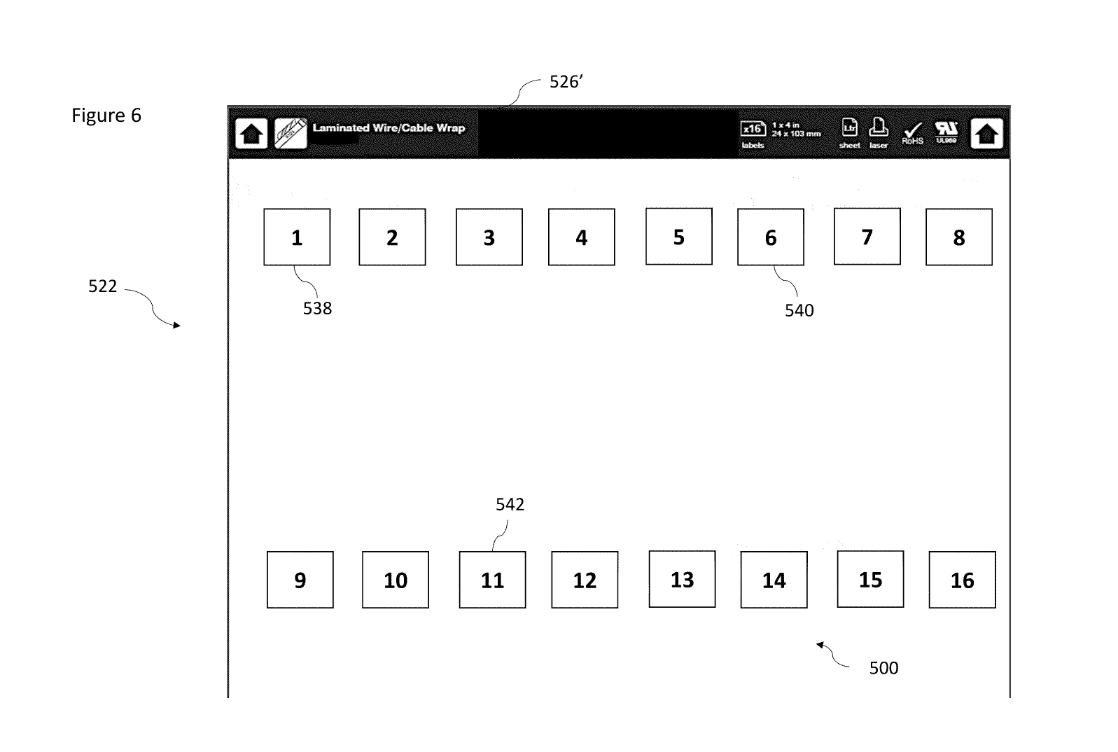

FIG. 6 shows a front side 522 of the sheet of labels 500. The identifiers 533 are printed with a size and/or thickness and/or density such that the identifier is visible through the image receiving layer 212 when viewed from the front side 222. In some embodiments, the thickness of the image receiving layer and/or adhesive layer is selected to ensure that the identifiers are visible from the front side. Also shown in FIG. 6 is header 526′, which contains the same information as header 526 shown on the reverse side of the label sheet 500. In some embodiments, identifiers may only be visible through the backing layer and not both the backing layer and the image receiving layer, such that the identifiers are visible from the front of the sheet for only those labels removed (causing the user to intuit the next available label identifier from the last used label identifier that is visible).

The identifiers are printed on the backing layer such that they are readable in their normal, or forward (e.g. left to right), orientation when viewed from the front side 522 of the label sheet. Therefore when the identifiers 533 are printed on the second side 208 of the backing layer they are printed in a reversed or mirrored orientation. If the identifiers 533 are printed on the first side 206 of the backing layer then they can be printed in their normal orientation. It will therefore be appreciated that the identifiers, in this case numbers 1 to 16, are visible in their normal orientation from the front side of the label sheet.

Each identifier, in this case each of numbers 1 to 16, is associated with a respective label. For example in the sheet of labels of FIG. 6 the number “1” is associated with a label 538, the number “5” is associated with a label 540, and the “11” is associated with a label 542 etc. In this example the numbers are centre aligned in their respective label.

Label sheets according to the described embodiment may facilitate the labelling of objects, particularly where labels having the same content need to be duplicated. In some embodiments the identifiers remain visible, or at least sufficiently visible, after printing on the label, such that an association can still be made between a label and its identifier. With respect to wire marking for example, it is often the case that a user needs to affix two or more labels having the same data content at different locations on the same wire or cable. Sometimes such wire or cable marking is carried out in teams of people, who need to communicate with each other as to which label they are sticking to which cable. Some of the embodiments may simplify this procedure since one operator can simply say to another operator, for example, “use label 4 for this cable”, rather than having to describe the content of the label. Label content may comprise long and complicated character strings, which may be very similar to content of other similar labels. Therefore embodiments facilitate correct labelling.

It will be understood that the numbering system and layout shown in FIGS. 5 and 6 is by way of example only and that other layouts and styles may be provided. For example the identifier may be a letter (e.g. A, B, C etc.) rather than a number. Alternatively a combination of letters and numbers may be used (e.g. A1, B1, C1, etc.). Furthermore the font used for the identifier, the size of the identifier, the thickness of the identifier etc. may be varied. Also the number of identifiers on the sheet may vary, for example in proportion to the number of labels on the front side of the sheet.

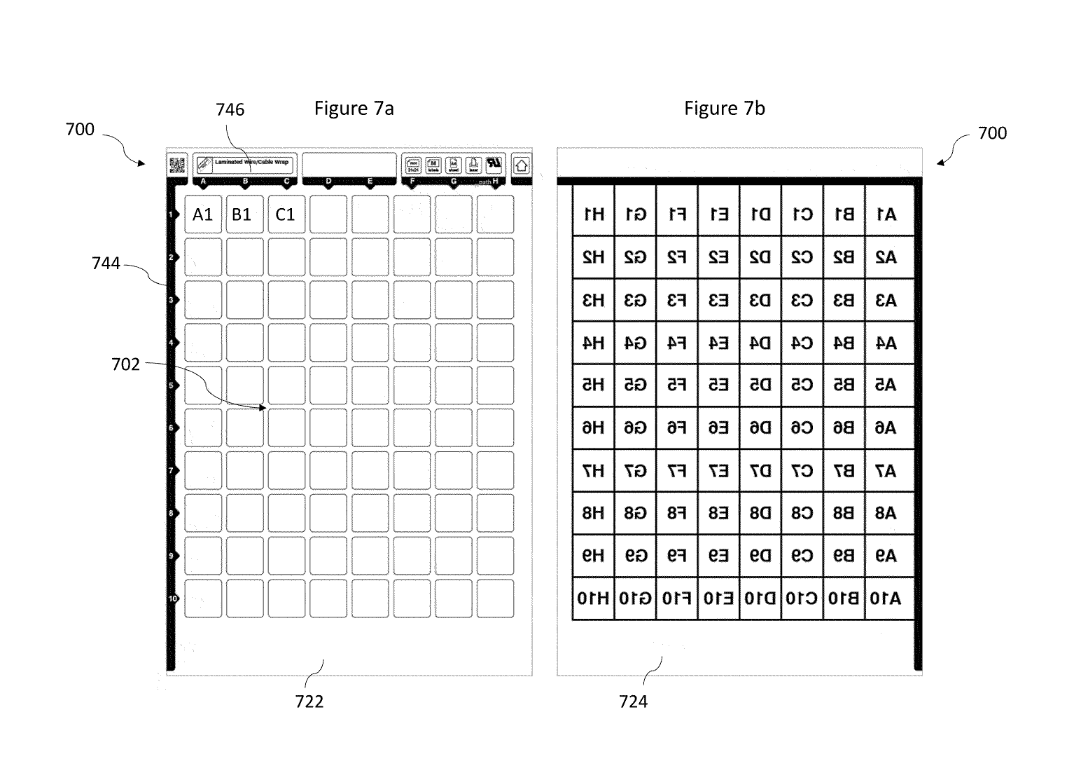

FIGS. 7A and 7B respectively show a front side 722 of another example label sheet 700 and a reverse side 724 of the label sheet 700. The front side 722 comprises a plurality of labels 702. As shown in FIG. 7B, a grid comprising identifiers (A1, B1, C1 . . . F10, G10, H10) is printed on the reverse side 724 of the label sheet 700. Each of these identifiers corresponds with one of the plurality of labels 702 on the front side 722 of the label sheet. Although only shown with respect to labels A1, B1, C1, F10, G10 and H10, the identifiers are visible through the adhesive layer and the image receiving layer such that they can be read from the front side of the label sheet 700. The front side 722 further comprises a border showing row numbers 744 and column lettering 746. Whilst a user could extrapolate an identifier for any given label using the borders 744 and 746, it is simpler and quicker for the user to directly read the identifiers printed on the reverse side 724 and which are visible from the front side 722. It is appreciated that, according to some embodiments, label identifiers may be provided solely embodied as borders defining the grid by row numbers and column numbers, such as row numbers 744 and column numbers 746.

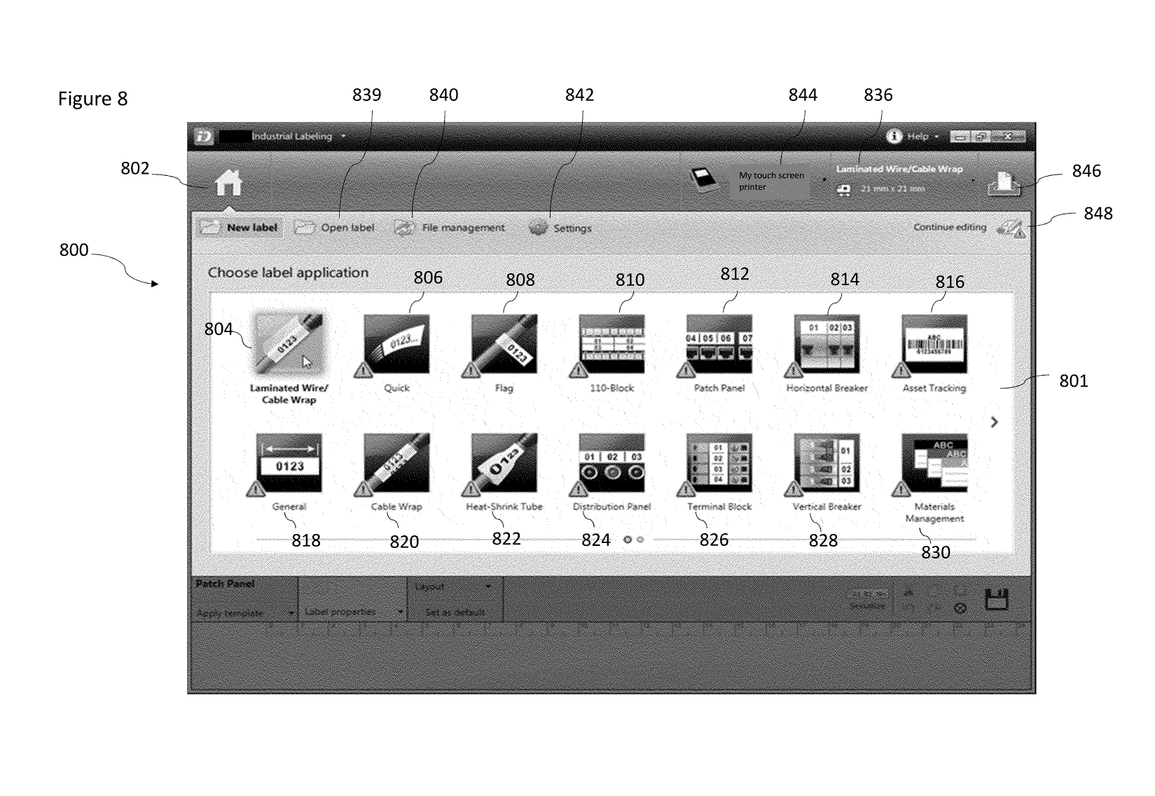

FIG. 8 generally shows a user interface 800 according to an embodiment. The user interface 800 may be presented on a monitor of a PC or on a display of a printing apparatus or a device to which the printer is connected. A user can navigate about the user interface 800 by known means. For example the user may operate a mouse or tracker-ball and can select options on the user interface 800 by placing a mouse pointer over an icon and clicking on that icon to select it. However it should also be appreciated that in other embodiments, for example where a touchscreen is used, the user may directly touch the screen or display so as to select icons and enter information. A user may also use a hardware keyboard or the like attached to a PC or directly attached to a label printer for navigating about the user interface.

In the embodiment of FIG. 8 a user has clicked on home icon 802, so that the user is now presented with home screen 801. This presents the user with a number of label types which may be selected by clicking on their respective icon. These label types include a laminated wire / cable wrap 804, a quick label 806, a flag label 808, a 110-block label 810, a patch panel label 812, a horizontal breaker label 814, an asset tracking label 816, a general label 818, a cable wrap label 820, a heat-shrink label 822, a distribution panel label 824, a terminal block label 826, a vertical breaker label 828, and a materials management label 830. It will be appreciated that further label types may alternatively or additionally also be displayed on the home screen 801.

It will be appreciated that the display may display one or more label types. Those label types may comprise one or more of the label types discussed previously and/or one or more other label types.

All of the label type icons except the laminated wire/cable wrap icon 804 are shown with an associated exclamation mark icon. This informs the user that these label types are not available in the given context. For example it may not be possible to print those label types on the selected type of label material. The selected type of label material is shown at portion 836 of the user interface 800.

Other options are also available to a user via user interface 800. These include an “Open label” icon 839. By clicking on this icon the user can open a previously saved label. By clicking on “File management” icon 840 the user enters a further interface where the user can manage their saved files, such as renaming the file and transferring the files to and from a label printer. The user can also access a settings menu via icon 842 for changing settings of the user interface. For example the user can change the language setting and whether to use imperial or metric units.

By clicking on icon 844 the user is presented with a drop down list of available printers. The type of printer selected may for example determine the types of label that are available to a user and/or formatting options available.

Icon 846 is a “quick print” icon which enables a user to quickly print a currently displayed label by clicking on icon 846.

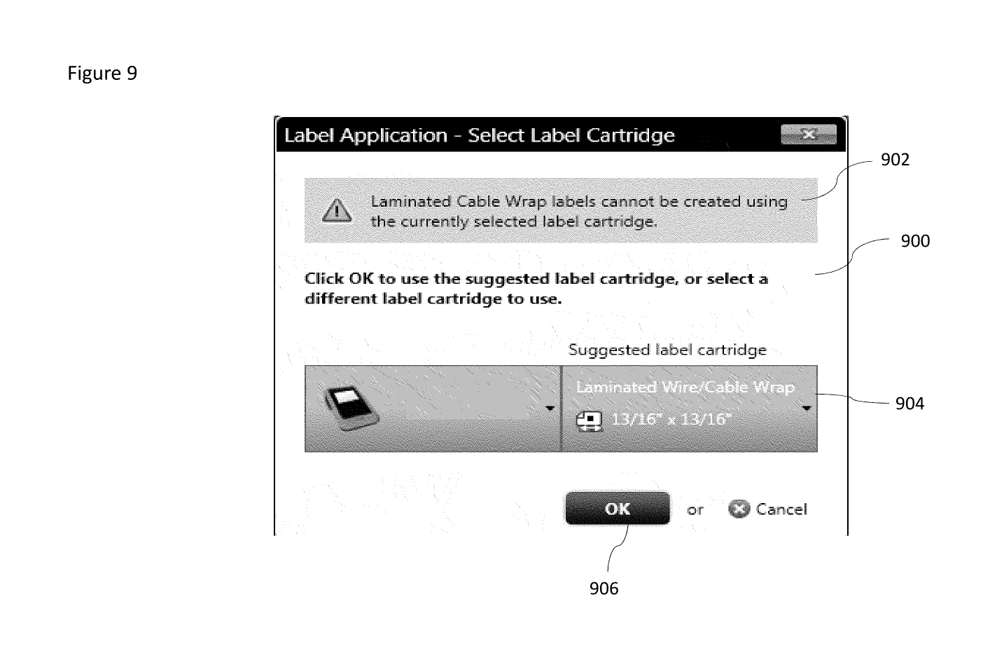

If a user is already in the process of preparing a label, and has exited the label editing screen for any reason, then they can quickly return to editing that label by clicking on “continue editing” icon 848.

Where a user selects a label type which cannot be printed on the type of labels currently in the printing apparatus then a warning screen 900 may be presented to a user, as shown in FIG. 9. In this example the laminated wire/cable wrap icon 804 has been selected, and the pop-up screen 900 states “laminated cable wrap labels cannot be created using the currently selected label cartridge”. The pop-up screen 900 also suggests a suitable label cartridge, as shown at 904. A user can accept this selection by clicking the “OK” button 906.

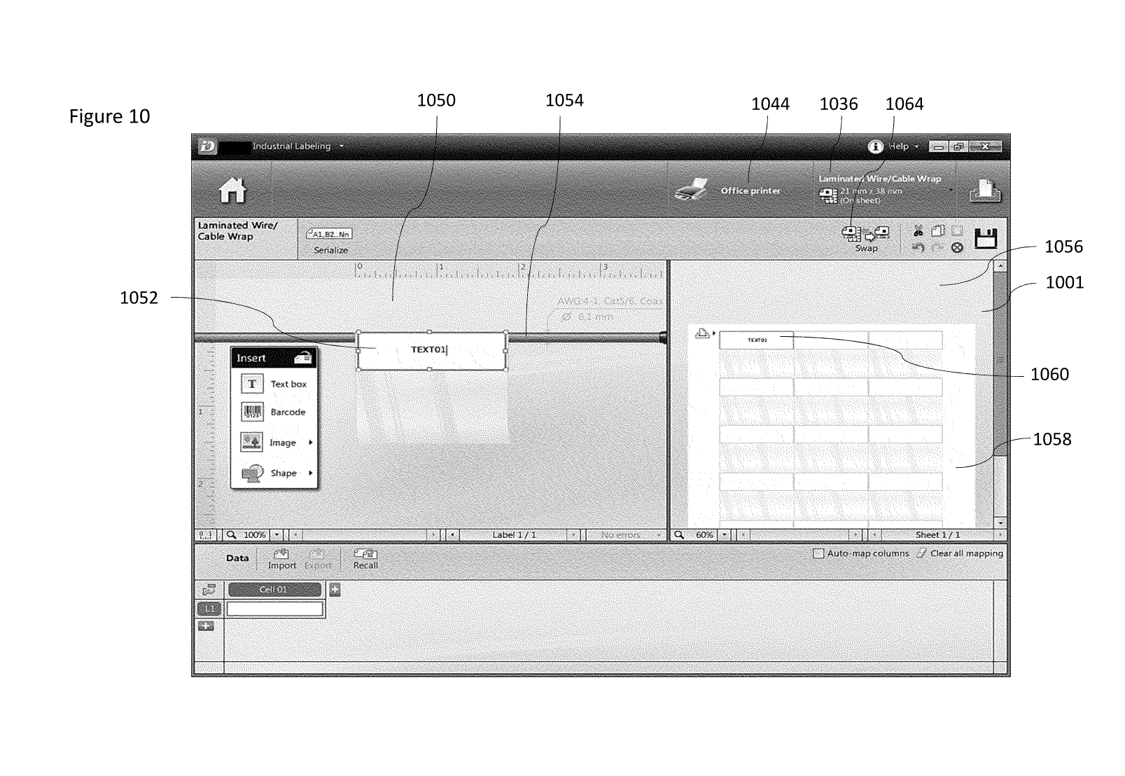

FIG. 10 shows an example of the user interface when a user is preparing a laminated wire/cable wrap label. As shown at region 1044 the user has selected an “Office printer”, and as shown at 1036 the label medium comprises 21 mm×38 mm labels on a label sheet. A first portion 1050 of the user interface 1001 displays a “What You See Is What You Get” (WYSIWYG) preview of a label being edited 1052, and a preview of the wire or cable 1054. In a second region 1056 of the user interface 1001 there is provided an image representative of a sheet of labels 1058 upon which printing will take place.

In the label preview 1052 the user has entered the text “TEXT01”. This text is also shown in first label 1060 on the image representative of the sheet of labels 1058.

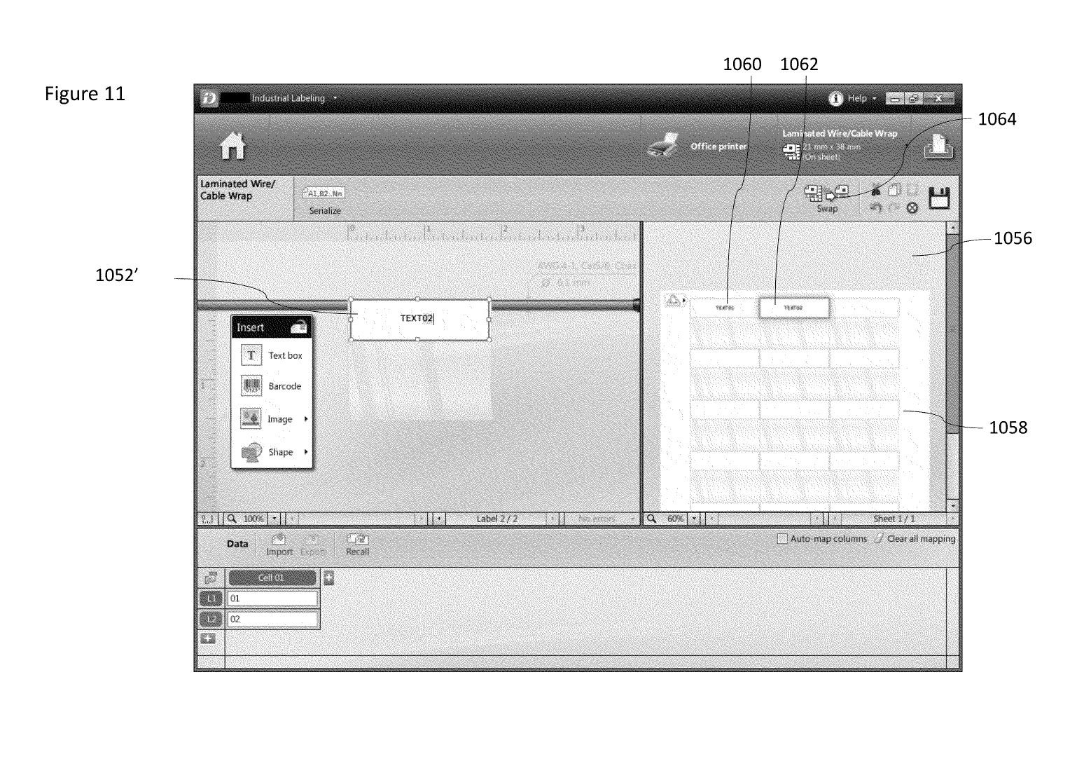

FIG. 11 is a continuation of FIG. 10. In this Figure the user is preparing a second label denoted by 1052′. In this label the user has entered the text “TEXT02”,and accordingly a second label is displayed at 1062 in the image representative of a sheet of labels 1058. The label 1062 also comprises the text “TEXT02”, as per label image preview 1052′.

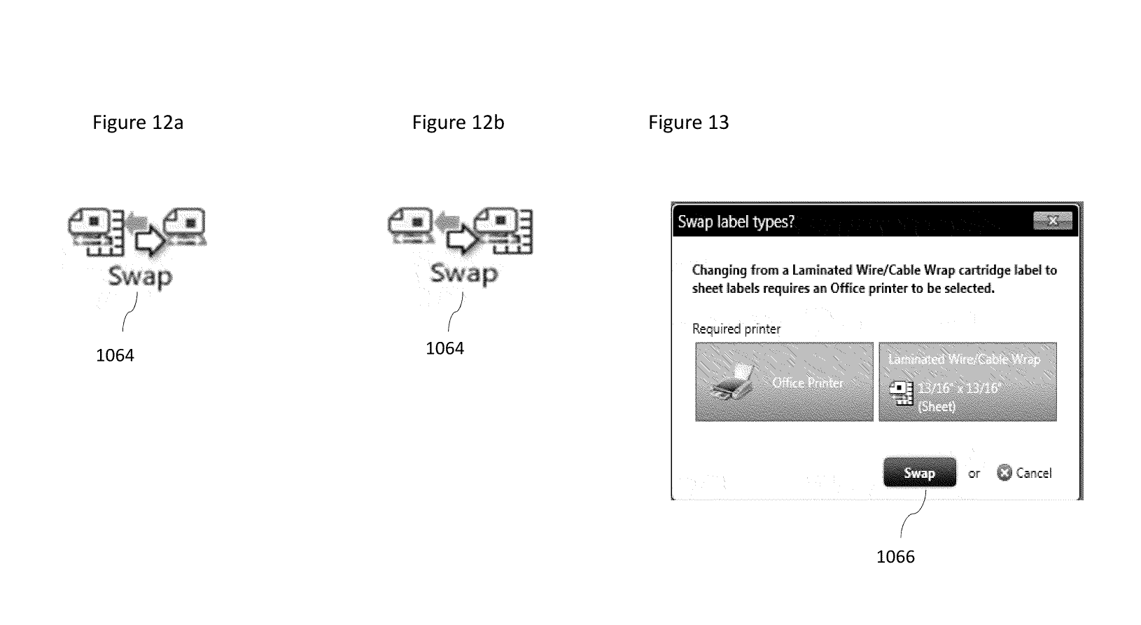

Also visible in FIGS. 10 and 11 is “Swap” button 1064. As shown in FIG. 12A the user can use the swap button 1064 to swap from a sheet of labels to a roll of labels as the selected image receiving medium type, or as shown in FIG. 12B the user can use the swap button 1064 to swap from a roll of labels to a sheet of labels as the selected image receiving medium type. The second region 1056 will update accordingly. For example when the user has swapped from the sheet of labels 1058 shown in FIGS. 10 and 11 to a roll of labels, then the second region 1056 of the user interface will update to be representative of a label supply on a roll.

Most tape printers are unable to print onto paper sheets. Therefore when switching or swapping from a roll supply to a sheet supply then the user is informed that an office printer must be selected as the printer, as shown for example in FIG. 13.

The user can confirm the swap by selecting “Swap” button 1066 as shown in FIG. 13.

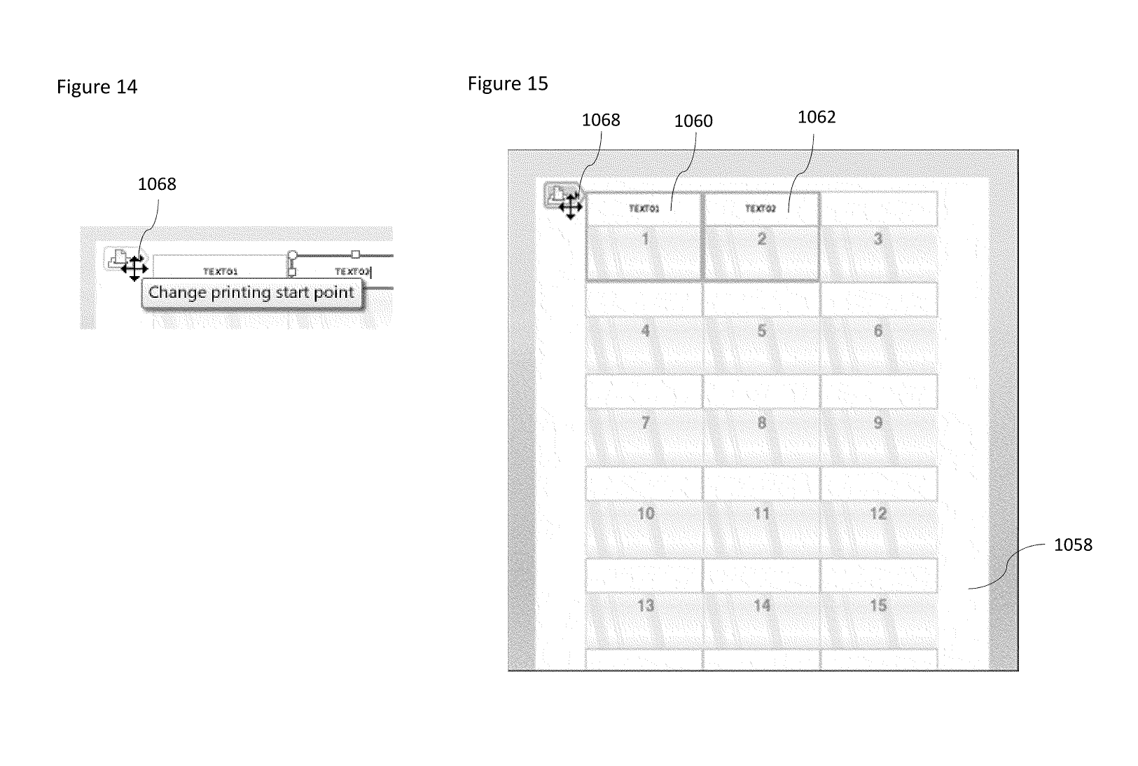

A further function that is available to a user is a “change printing start point” function, as shown in FIG. 14. This function enables a user to change a print starting point of data, which data may have already been entered.

As shown in FIG. 15 a user has selected the change print start point function on the user interface, and has selected labels 1060 and 1062. As also shown in FIG. 15, upon selection of the change print start point function each label in the image 1058 has been designated an identifier, in this case a number position below each label. For example the first label (top left) has been designated “1”, the second label has been designated “2”, the third label has been designated “3” and so on. In other embodiments the identifiers are also present before the “change printing start point function” is selected. This helps a user to visualise upon which labels on the actual label sheets printing will take place. In embodiments, the identifiers (e.g. numbers) shown in label image 1058 correspond to the identifiers (e.g. numbers) displayed on the label sheet itself upon which printing is to take place (for example the numbers on the label sheet described with respect to FIGS. 5 to 7B). In a case where some of the labels on a label sheet have already been used, then a user can easily see from the label sheet which labels are still available, and begin printing from that particular label by selecting that label as the starting point for printing. For example a user may look at a label sheet that is in the printer or is to be inserted in the printer, and see that the first two labels have already been used (e.g. printed on and/or removed). Accordingly the user wants to begin printing from the third label (label “3”). According to embodiments a user can specify on the user interface that printing is to start from the third label (identified by the identifier “3”) in the image 1058.

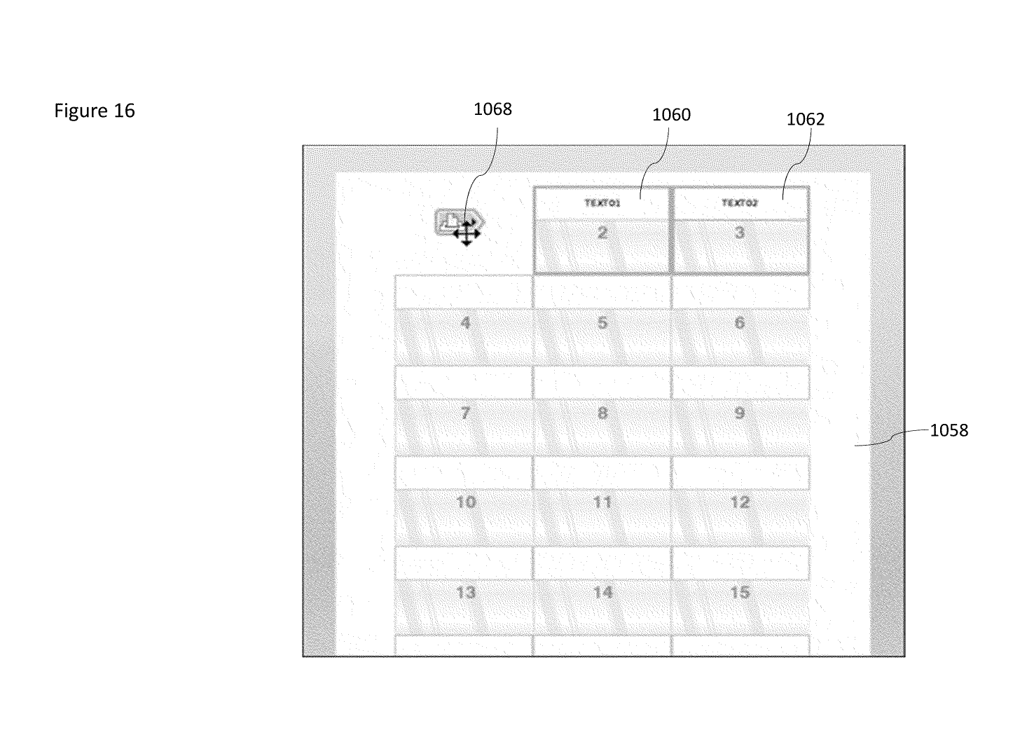

As shown in FIG. 16 the user has moved the two selected labels 1060 and 1062 to the right, such that they now occupy label spaces “2” and “3”.

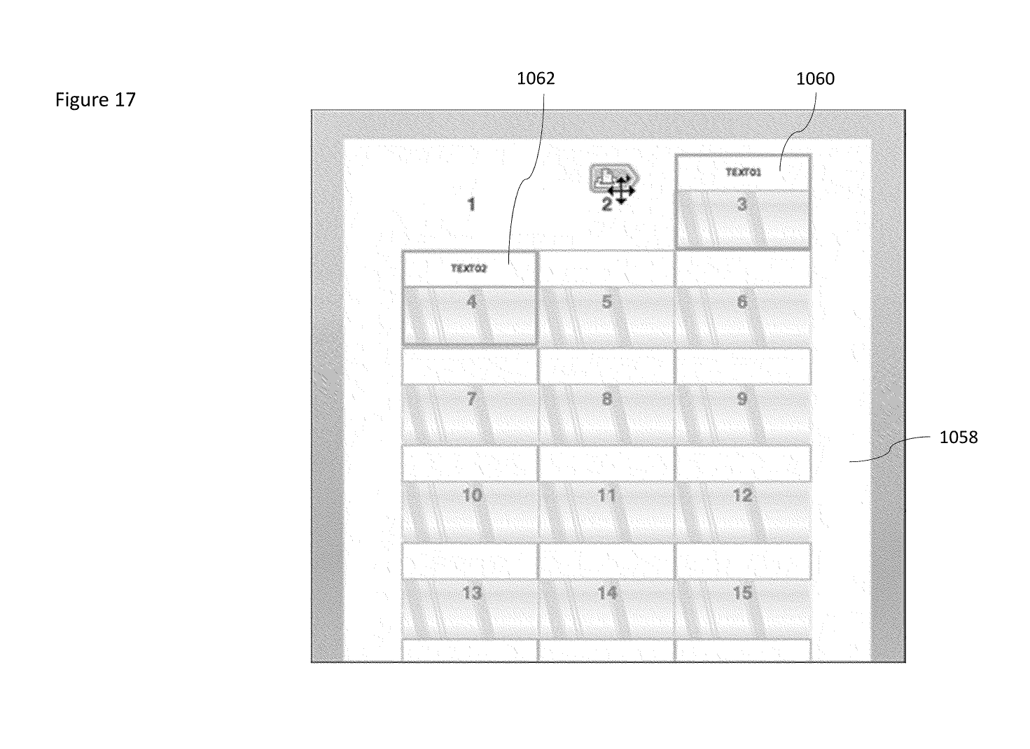

As shown in FIG. 17 the user has moved the selected labels along one further position, such that the labels 1060 and 1062 now occupy slots 3 and 4 on image 1058. Thus when a user accepts this selection and instructs the printer to print, printing will take place on the third and fourth labels (labels designated by identifiers “3” and “4”) of the corresponding label sheet in the printer.

In other embodiments a user does not have to move labels as a block. Rather a user can move label data individually to any label position on image 1058. This may be useful where a user does not want to print on sequential labels, for example where labels have been previously removed from a sheet in a non-sequential manner. For example the only labels remaining on a sheet may be in positions 4, 7, 9 and 11. Therefore a user can enter label data in or move label data to any of those label positions to cause printing on those label positions only.

Although a sixteen-label sheet has been described in FIGS. 10 to 17, it will be appreciated that this is by way of example only and that other label sheets having more or fewer labels may be provided. In some embodiments the type of label sheet inserted in the printer is automatically detected. In other embodiments a user selects the type of label sheet from the user interface.

Although the embodiments have shown a user entering data in a first (top-left) label and then subsequently moving data from that label position to another label position, it will also be appreciated that in other embodiments a user can begin entering data at any label position in the image representative of a label sheet at the beginning of the label creation process, and it should be understood that a user is not required to start at the first unused label, but instead could start at any label irrespective of what labels have or have not been utilized.

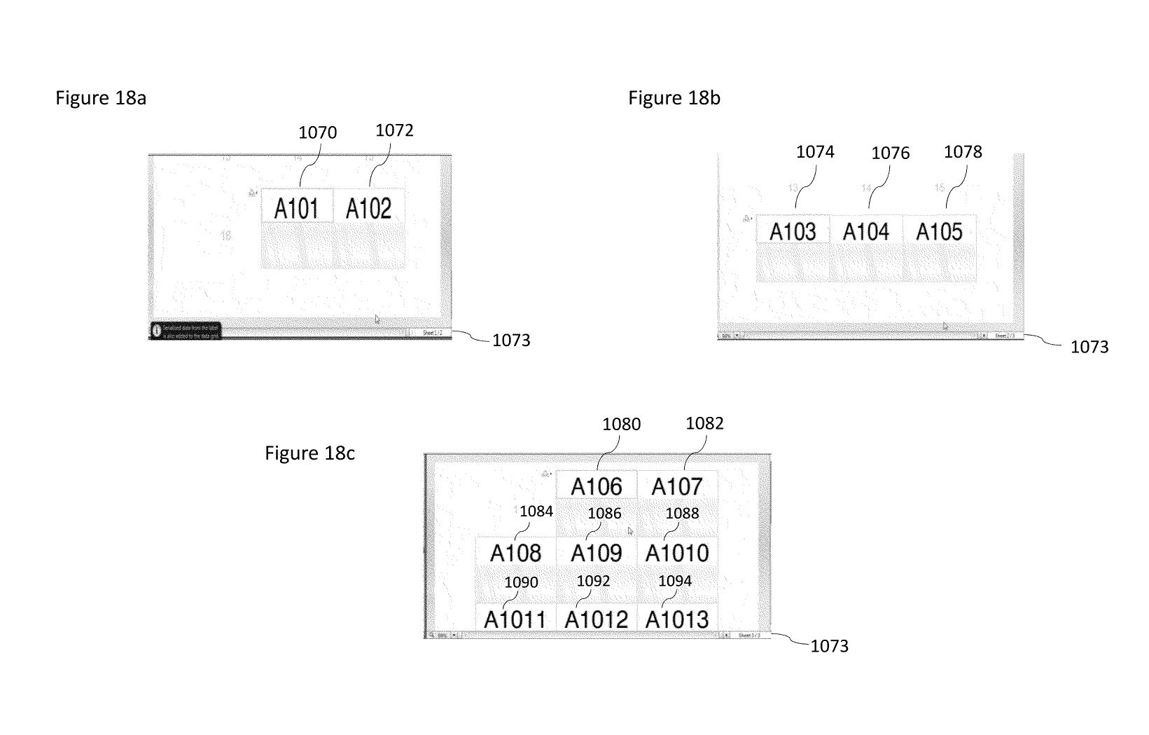

According to embodiments a user can also cause data to be printed on selected label regions on consecutive sheets. The user can also, using the methods described above (e.g. the change printing start point function) move label data to be printed between the various sheets. For example as shown in FIG. 18A a user has entered data “A101” into a first label 1070, and has entered the data “A102” into a second label 1072. These labels are disposed on a first sheet of labels as shown by region 1073. In a second sheet as shown in region 1073 and FIG. 18B, a user has entered label data “A103”, “A104”, “A105” in labels 1074, 1076 and 1078 respectively.

On a third sheet the user has entered data for labels 1080, 1082, 1084, 1086, 1088, 1090, 1092 and 1094 as shown. Printing will then take place on the three sheets as displayed in FIGS. 18A to 18C. As described above a user can selectively move data between the sheets.

Whilst embodiments have been described in the context of label sheets, embodiments of the invention are also applicable to continuous tape or labels on a roll. For example a user may only want to print on certain labels in a label roll, and leave some labels blank or some regions of a continuous tape blank. The identifiers visible from the front side of the label roll or continuous tape may facilitate this. The tape or die cut labels may be provided in a cassette or simply on a roll. Alternatively, instead of or in addition to a label identifier on a label roll, a distance identifier may be provided (e.g., a ruler with a measurement running the length of the tape), allowing the user to indicate where to start a print job along the length of a roll or tape, or how much blank space to leave between print jobs on a single roll or tape.

The foregoing merely illustrates the principles of certain embodiments. Modifications and alterations to the described embodiments will be apparent to those skilled in the art in view of the teaching herein. It will thus be appreciated that those skilled in the art would be able to devise numerous techniques which although not explicitly described herein, embody the principles of the described embodiments and are thus within the scope defined by the claims.

1. A sheet of labels comprising:
a backing layer forming a reverse side of the sheet of labels;
and an image receiving layer attached to the backing layer, the image receiving layer comprising a plurality of removable labels and forming a front side of the sheet of labels;
the backing layer comprising at least one identifier associated with each of the plurality of labels, one or more of the at least one identifier being at least partially visible from the front side of the sheet of labels.

2. A sheet of labels as set forth in claim 1, wherein one or more of the at least one identifier is at least partially visible from the front side of the sheet of labels through at least the backing layer.

3. A sheet of labels as set forth in claim 1, wherein one or more of the at least one identifier is at least partially visible from the front side of the sheet of labels through at least the backing layer at a location associated with a removed label from the plurality of labels.

4. A sheet of labels as set forth in claim 3, wherein the location is directly underneath the removed label.

5. A sheet of labels as set forth in claim 1, wherein one or more of the at least one identifier is at least partially visible from the front side of the sheet of labels through the image receiving layer at a location associated with a label that has not been removed from the plurality of labels.

6. A sheet of labels as set forth in claim 1, wherein the backing layer comprises a first side and a second side, an adhesive layer attached to the first side, and the second side comprising the reverse side of the sheet of labels.

7. A sheet of labels as set forth in claim 6, wherein the at least one identifier comprises a marking printed on the first side of the backing layer.

8. A sheet of labels as set forth in claim 6, wherein the at least one identifier comprises a marking printed on the second side of the backing layer.

9. A sheet of labels as set forth in claim 8, wherein the at least one identifier is printed on the second side in a reverse manner, so that the at least one identifier is visible in a forward manner from the front side.

10. A sheet of labels as set forth in claim 1 comprising a plurality of identifiers, each identifier associated with a respective one of said plurality of labels.

11. A sheet of labels as set forth in claim 10, the plurality of identifiers being arranged in a grid.

12. A sheet of labels as set forth in claim 10, the plurality of identifiers comprising a plurality of different characters or character strings, each character or character string representing a respective one of said plurality of labels.

13. A sheet of labels as set forth in claim 12, each character or character string comprising one or more numbers and/or letters.

14. A method of manufacturing a sheet of labels comprising:
providing a backing layer forming a reverse side of the sheet of labels;
providing at least one identifier on the backing layer;
providing an image receiving layer, the image receiving layer comprising a plurality of removable labels and configured to form a front side of the sheet of labels;
and attaching the backing layer to the image receiving layer, the at least one identifier being associated with the plurality of labels and the at least one identifier being visible from the front side of the plurality of labels through the image receiving layer.

15. A method as set forth in claim 14, comprising locating the at least one identifier directly underneath the plurality of removable labels.

16. A method as set forth in claim 14, wherein the backing layer comprises a first side and a second side, the method comprising applying an adhesive layer to the first side, the second side comprising the reverse side of the sheet of labels.

17. A method as set forth in claim 16, comprising printing the at least one identifier on the first side of the backing layer.

18. A method as set forth in claim 16, comprising printing the identifier on the second side of the backing layer.

19. A method as set forth in claim 18, comprising printing the identifier on the second side in a reverse manner, so that the at least one identifier is visible in a forward manner from the front side, and providing a plurality of identifiers, each identifier associated with a respective one of said plurality of labels, and arranging the plurality of identifiers in a grid.

20. A non-transitory computer readable medium comprising code means adapted to perform a method comprising:
displaying on a user interface for controlling a printer an image representative of a sheet comprising a plurality of labels;
displaying on the image representative of a sheet of labels at least one identifier, the identifier associated with at least one of said labels in the image;
the identifier indicative of an association between the labels displayed in the image and one or more labels on a sheet of labels capable for printing in a printer; and
enabling a user to enter data to be printed in to the image representative of a sheet of labels.
